(19) United States
(12) Patent Application Publication
(10) Pub. No.: US 2010/0221019 A1
(43) Pub. Date: Sep. 2, 2010

(54) Low-noise parallel cascade of optical receivers

(76) Inventors: Wanda Wolodkowicz, Santa Clara, CA (US); Krzysztof Pradzynski, Santa Clara, CA (US); Oleh Sniezko, Highlands Ranch, CO (US); Sudhesh Mysore, Carlsbad, CA (US)

Correspondence Address: JOHN BRUCKNER PC, P.O. BOX 17569, SUGAR LAND, TX, 77496-7569, US

(21) Appl. No.: 12/660,196

(22) Filed: Feb. 19, 2010

Related U.S. Application Data
(60) Provisional application No. 61/208,167, filed on Feb. 19, 2009.

(51) Int. Cl. H04B 10/06

(52) U.S. Cl. 398/202

(57) ABSTRACT

A method includes cascading outputs from a plurality of photodiodes connected in parallel; and amplifying the cascaded outputs. An apparatus, includes a plurality of photodiodes cascaded in parallel; and an amplifier coupled to the plurality of photodiodes.

### CROSS-REFERENCE TO RELATED APPLICATION

This application claims a benefit of priority under 35 U.S.C. 119(e) from copending provisional patent application U.S. Ser. No. 61/208,167, filed Feb. 19, 2009, the entire contents of which are hereby expressly incorporated herein by reference for all purposes.

### BACKGROUND INFORMATION

1. Field of the Invention

Embodiments of the invention relate generally to the field of optical networking. More particularly, embodiments of the invention relate to methods and apparatus for providing low-noise parallel cascades of optical receivers.

2. Discussion of the Related Art

There are many applications where the outputs of several optical receivers have to be electrically combined together. For example, in Fiber-to-the-Home (FTTH) networks, optical receivers that collect return signals from a small group of subscribers may then have to be aggregated in order to increase the logical “service area”, thereby decreasing the number of expensive Cable Modem Termination Systems (CMTS) that are required to terminate and process the data traffic. In optical sensor networks, the outputs of many optical sensors may have to be combined together to keep the number of signals within manageable bounds. In computer networks, the outputs of many optical receivers on a motherboard may have to be combined into a single signal.

The signals from optical receivers typically are fed to much more expensive signal processing equipment. Combining the outputs of many optical receivers reduces the number of such expensive signal processors, albeit with lower dedicated bandwidth per receiver. The resulting cost reduction can be very attractive if the reduced bandwidth per receiver is within design guidelines and if the combining of the outputs of the receivers is done in an inexpensive manner that does not increase the amount of electrical noise by such an extent that the signal-to-noise ratio (SNR) falls below acceptable levels at the signal processing equipment that is connected to the receivers.

An example where combining of optical receivers is desirable is a FTTH network is shown in FIG. 1. Cable modems located at the customer premises communicate with CMTS 100 located at the FTTH node, hub or cable head-end (HE). Laser transmitters in the Optical Network Terminal (ONT) convert cable modem signals into optical signals. The optical signals from 32 subscribers (the numbers here are just used for example, any number of subscribers can be attached and typically this number for FTTH networks ranges between 16 and 128, the number of subscribers per single optical fiber is called herein a split ratio) are combined onto a single optical fiber 110 which goes to a receiver 120 located in the FTTH node, hub or head-end. From here, the signals go to a CMTS 100 located in the same or any other node, at the hub or cable head-end (HE).

It would be possible for the 32 subscribers (subscribers served by a single reverse or upstream receivers) on each optical fiber to be connected to a single CMTS. However, this would be prohibitively expensive and the design of a conventional hybrid fiber-coax (HFC) is such that a CMTS typically serves up to 500 to 2000 homes passed (HP) or 100 to 800 high-speed data (HSD) subscribers to lower the cost of providing the HSD service, especially where and when bandwidth does not justify lower number of subscribers. Combining the optical signals from, for example, sixteen fibers before connecting them to a CMTS would result in a node serving area of 512 HP (if 32 HP are served with a single fiber but this number can be different and typically ranges between 16 and 128 in FTTH passive optical networks (PONs)). Combining a larger or smaller number of receivers for larger or smaller service areas is possible and performed in HFC networks that are delivering HSD services today. The level of combining depends on required bandwidth per subscriber, level of service penetration and level of services (in data capacity terms) offered by the operator. If greater data capacity per subscriber is desired, then only eight fibers could be combined together, resulting in a node serving area of 256 HP rather than 512 HP. Again, the number of subscribers is just an example not meant to limit the application of this invention. Any larger and any smaller number can be combined into a single service area.

In the FTTH node, in the hub or in the HE, the optical signal from each fiber is detected by an optical receiver. The outputs of any number of the receivers are then combined and this composite signal then is connected to the CMTS in FTTH node, hub or HE or drives a second optical link from the FTTH node to the hub or HE where the CMTS can be located.

### SUMMARY OF THE INVENTION

There is a need for the following embodiments of the invention. Of course, the invention is not limited to these embodiments.

According to an embodiment of the invention, a method comprises: cascading outputs from a plurality of photodiodes connected in parallel; and amplifying the cascaded outputs. According to another embodiment of the invention, an apparatus comprises: a plurality of photodiodes cascaded in parallel; and an amplifier coupled to the plurality of photodiodes.

These, and other, embodiments of the invention will be better appreciated and understood when considered in conjunction with the following description and the accompanying drawings. It should be understood, however, that the following description, while indicating various embodiments of the invention and numerous specific details thereof, is given for the purpose of illustration and does not imply limitation. Many substitutions, modifications, additions and/or rearrangements may be made within the scope of an embodiment of the invention without departing from the spirit thereof, and embodiments of the invention include all such substitutions, modifications, additions and/or rearrangements.

### BRIEF DESCRIPTION OF THE DRAWINGS

FIG. 1 illustrates a return path of a FTTH network illustrating combining optical receivers in the FTTH node or in the head-end, resulting in a logical node serving an area much larger than the single fiber serving area that would be provided in such an FTTH.

FIG. 2 illustrates a method of combining the outputs of multiple optical receivers.

FIG. 3 illustrates a low-noise method of combining the outputs of multiple optical receivers.

### DESCRIPTION OF PREFERRED EMBODIMENTS

Embodiments of the invention and the various features and advantageous details thereof are explained more fully with reference to the nonlimiting embodiments that are illustrated in the accompanying drawings and detailed in the following description. Descriptions of well known starting materials, processing techniques, components and equipment are omitted so as not to unnecessarily obscure the embodiments of the invention in detail. It should be understood, however, that the detailed description and the specific examples, while indicating preferred embodiments of the invention, are given by way of illustration only and not by way of limitation. Various substitutions, modifications, additions and/or rearrangements within the spirit and/or scope of the underlying inventive concept will become apparent to those skilled in the art from this disclosure.

In general, the context of an embodiment of the invention can include fiber to the home networks. The context of an embodiment of the invention can include combination topologies that yield low noise.

The combining of multiple receivers is critical in making the FTTH system comparable in cost to a conventional HFC system. Otherwise, many more CMTS units would have to be deployed thus significantly increasing the cost of providing HSD services. Furthermore, it is essential that adequate SNR be maintained. It is even more important if two optical links are cascaded (subscriber-to-node and node-to-hub/HE). Therefore, the combining of optical receivers at the FTTH node, hub or HE must be done in a way that does not result in a large increase in noise. If combining of the receivers results in a large noise penalty, then the bandwidth of the optical link would have to be reduced in order to get the same effective SNR as without combining, or the reach of the FTTH network would have to be much shorter to improve SNR, or the split ratio would have to be lower (to reduce loss and thus increase optical input level to the receiver for better SNR) resulting in higher cost or higher number of fibers arriving to the FTTH node, hub or HE.

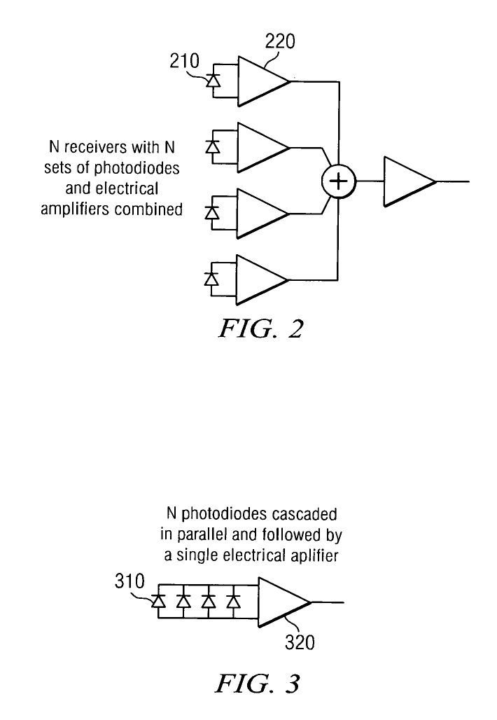

A method of combining optical receivers is shown in FIG. 2. FIG. 2 shows N receivers with N sets of photofiodes and electrical amplifiers combined. In this method, each optical photodiode (pin or APD) 210 is followed by an electrical amplifier 220, the outputs of which are then electrically combined. Standard impedance-matching circuits are used to match the impedance of the amplifiers (typically 50 or 75 ohms). In this method, thermal noise (the dominant noise in FTTH networks where the optical input level to the receivers is very low) from each photodiode/amplifier combination is added together and the resultant thermal noise is a linear sum of the individual thermal noise. This decreases SNR and limits the number of receivers combined or the bandwidth per receiver, or the reach of FTTH network, or the split ratio.

Embodiments of the invention can include an alternative method of combining the outputs of multiple optical receivers that results in lower thermal noise than in the method shown in FIG. 2. The alternative method is shown in FIG. 3.

FIG. 3 shows N photodiodes cascaded in parallel and followed by a single electrical amplifier. The photodiodes 310 are cascaded in parallel and are then followed by an electrical amplifier 320. Since reverse-biased photodiodes have relatively high impedance (tens of kohms or higher), there is no need for impedance-matching networks when connecting the photodiodes together in parallel.

The lack of impedance-matching or combining networks means that embodiments of the invention can be scaled up easily to combine large numbers of photodiodes—from a few and tens of photodiodes (when receiver bandwidth in the GHz range is desired) to hundreds or even thousands of photodiodes (when the bandwidth is only required to be in the MHz range). The limit on the number of receivers that can be cascaded in parallel is the accumulation of parasitic capacitance. Low parasitic capacitance photodiodes can be employed to obtain the maximum number of parallel cascades possible.

Embodiments of the invention combining N optical receivers employ a single electronic amplifier instead of N amplifiers. Since thermal noise generated in pin photodiodes is orders of magnitude lower than that generated in electronic amplifiers, this means that the total thermal noise is reduced by a factor of N in the proposed method in comparison to the method of N amplifiers. This is an important advantage of the invention as explained below.

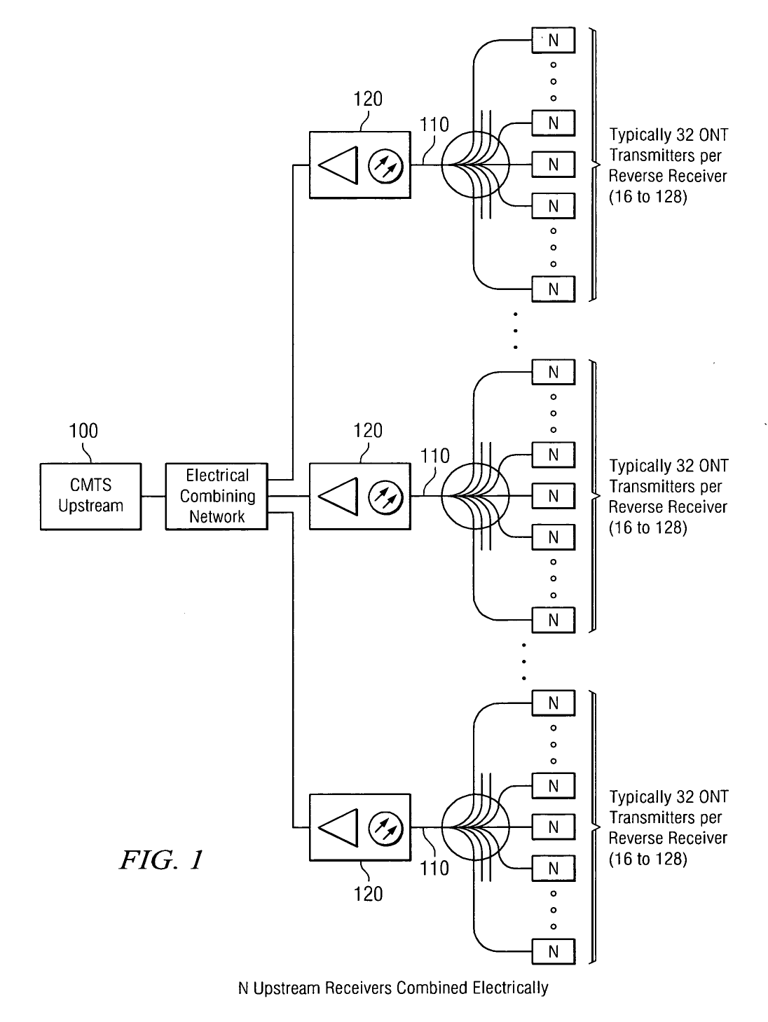

This reduction in noise can be a critical factor in providing adequate SNR so that FTTH networks (such as shown in FIG. 1) can work without having to reduce the bandwidth of the optical receivers, or the reach of the FTTH network, or the split ratio.

Embodiments of the invention can be used with pin and APD photodiodes. The thermal noise of APD photodiodes is larger than that of pin photodiodes, but is still smaller than the thermal noise generated in electronic amplifiers. Thus, the total thermal noise of embodiments of the invention are still reduced compared to the N amplifiers method, albeit by a factor less than N. Since APD receivers provide larger SNR to start with, there is still a large improvement in SNR when APD receivers are combined using the proposed technique, making FTTH networks such as in FIG. 1 feasible for a long reach, wide bandwidth and/or high split ratios.

An embodiment of the invention can include outputs of multiple photodiodes (pin or APD) combined by connecting them in parallel, without the need for impedance-matching circuits.

An embodiment of the invention can include a single electrical amplifier to amplify the composite current signal (the sum of the individual photodiode currents).

An embodiment of the invention can have the advantage of a reduction in thermal noise by a factor close to N, where N is the number of photodiodes being combined.

Embodiments of the invention provide a simple method of combining large numbers of photodiodes—from tens of photodiodes (when bandwidth in the GHz range is desired) to hundreds or even thousands of photodiodes (when the bandwidth is only required to be in the MHz range). Low parasitic capacitance photodiodes can be employed to obtain the maximum number of parallel cascades possible.

An embodiment of the invention can also be included in a kit-of-parts. The kit-of-parts can include some, or all, of the components that an embodiment of the invention includes. The kit-of-parts can be an in-the-field retrofit kit-of-parts to improve existing systems that are capable of incorporating an embodiment of the invention. The kit-of-parts can include software, firmware and/or hardware for carrying out an embodiment of the invention. The kit-of-parts can also contain instructions for practicing an embodiment of the invention. Unless otherwise specified, the components, software, firmware, hardware and/or instructions of the kit-of-parts can be the same as those used in an embodiment of the invention.

### DEFINITIONS

The term program and/or the phrase computer program are intended to mean a sequence of instructions designed for execution on a computer system (e.g., a program and/or computer program, may include a subroutine, a function, a procedure, an object method, an object implementation, an executable application, an applet, a servlet, a source code, an object code, a shared library/dynamic load library and/or other sequence of instructions designed for execution on a computer or computer system).

The term substantially is intended to mean largely but not necessarily wholly that which is specified. The term approximately is intended to mean at least close to a given value (e.g., within 10% of). The term generally is intended to mean at least approaching a given state. The term coupled is intended to mean connected, although not necessarily directly, and not necessarily mechanically. The term proximate, as used herein, is intended to mean close, near adjacent and/or coincident; and includes spatial situations where specified functions and/or results (if any) can be carried out and/or achieved. The term distal, as used herein, is intended to mean far, away, spaced apart from and/or non-coincident, and includes spatial situation where specified functions and/or results (if any) can be carried out and/or achieved. The term deploying is intended to mean designing, building, shipping, installing and/or operating.

The terms first or one, and the phrases at least a first or at least one, are intended to mean the singular or the plural unless it is clear from the intrinsic text of this document that it is meant otherwise. The terms second or another, and the phrases at least a second or at least another, are intended to mean the singular or the plural unless it is clear from the intrinsic text of this document that it is meant otherwise. Unless expressly stated to the contrary in the intrinsic text of this document, the term or is intended to mean an inclusive or and not an exclusive or. Specifically, a condition A or B is satisfied by any one of the following: A is true (or present) and B is false (or not present), A is false (or not present) and B is true (or present), and both A and B are true (or present). The terms a and/or an are employed for grammatical style and merely for convenience.

The term plurality is intended to mean two or more than two. The term any is intended to mean all applicable members of a set or at least a subset of all applicable members of the set. The phrase any integer derivable therein is intended to mean an integer between the corresponding numbers recited in the specification. The phrase any range derivable therein is intended to mean any range within such corresponding numbers. The term means, when followed by the term “for” is intended to mean hardware, firmware and/or software for achieving a result. The term step, when followed by the term “for” is intended to mean a (sub)method, (sub)process and/or (sub)routine for achieving the recited result. Unless otherwise defined, all technical and scientific terms used herein have the same meaning as commonly understood by one of ordinary skill in the art to which this invention belongs. In case of conflict, the present specification, including definitions, will control.

### CONCLUSION

The described embodiments and examples are illustrative only and not intended to be limiting. Although embodiments of the invention can be implemented separately, embodiments of the invention may be integrated into the system(s) with which they are associated. All the embodiments of the invention disclosed herein can be made and used without undue experimentation in light of the disclosure. Although the best mode of the invention contemplated by the inventor(s) is disclosed, embodiments of the invention are not limited thereto. Embodiments of the invention are not limited by theoretical statements (if any) recited herein. The individual steps of embodiments of the invention need not be performed in the disclosed manner, or combined in the disclosed sequences, but may be performed in any and all manner and/or combined in any and all sequences. The individual components of embodiments of the invention need not be combined in the disclosed configurations, but could be combined in any and all configurations.

Various substitutions, modifications, additions and/or rearrangements of the features of embodiments of the invention may be made without deviating from the spirit and/or scope of the underlying inventive concept. All the disclosed elements and features of each disclosed embodiment can be combined with, or substituted for, the disclosed elements and features of every other disclosed embodiment except where such elements or features are mutually exclusive. The spirit and/or scope of the underlying inventive concept as defined by the appended claims and their equivalents cover all such substitutions, modifications, additions and/or rearrangements.

The appended claims are not to be interpreted as including means-plus-function limitations, unless such a limitation is explicitly recited in a given claim using the phrase(s) “means for” and/or “step for.” Subgeneric embodiments of the invention are delineated by the appended independent claims and their equivalents. Specific embodiments of the invention are differentiated by the appended dependent claims and their equivalents.

What is claimed is:

1. A method, comprising
cascading outputs from a plurality of photodiodes connected in parallel; and
amplifying the cascaded outputs.

2. The method of claim 1, wherein cascading and amplifying include substantially no impedance-matching.

3. The method of claim 1, wherein cascading defines a composite current signal and a single electrical amplifier is used to amplify the composite current signal.

4. An apparatus, comprising:
a plurality of photodiodes cascaded in parallel; and
an amplifier coupled to the plurality of photodiodes.

5. The apparatus of claim 4, wherein there is substantially no impedance-matching circuits.

6. The apparatus of claim 4, wherein the plurality of photodiodes cascaded in parallel define a composite current signal and a single electrical amplifier is used to amplify the composite current signal.

7. A network, comprising the apparatus of claim 4.
